(19) United States
(12) Patent Application Publication
(10) Pub. No.: US 2012/0031722 A1
(43) Pub. Date: Feb. 9, 2012

(54) HYDRAULIC TRANSMISSION APPARATUS

(75) Inventors: Yoshihiro TAKIKAWA, Tsushima-shi (JP); Kazuto MARUYAMA, Nishio-shi (JP); Kazuhiro ITOU, Anjo-shi (JP)

(73) Assignee: AISIN AW. CO. LTD., Anjo-shi (JP)

(21) Appl. No.: 13/205,296

(22) Filed: Aug. 8, 2011

(30) Foreign Application Priority Data
Aug. 9, 2010 (JP) 2010-178752

(51) Int. Cl. F16H 45/02

(52) U.S. Cl. 192/3.28

(57) ABSTRACT

A hydraulic transmission apparatus including a pump impeller connected to an input member that is coupled to a motor; a turbine runner for rotating with the pump impeller; a damper mechanism having an input element coupled to the turbine runner, an elastic body engaging with the input element, and an output element engaging with the elastic body and coupled to an transmission device input shaft; a lockup clutch for performing lockup in which the input member is engaged with the input element of the damper mechanism, and for releasing lockup; and an engagement mechanism engaging the turbine runner with the output element of the damper mechanism so that the turbine runner and the output element of the damper mechanism rotate integrally, when the lockup is released by the lockup clutch, and that does not engage the turbine runner with the output element of the damper mechanism so that the turbine runner and the output element of the damper mechanism do not rotate integrally, when the lockup is performed by the lockup clutch.

### INCORPORATION BY REFERENCE

The disclosure of Japanese Patent Application No. 2010-178752 filed on Aug. 9, 2010 including the specification, drawings and abstract is incorporated herein by reference in its entirety.

### BACKGROUND OF THE INVENTION

The present invention relates to hydraulic transmission apparatuses including a damper mechanism having an input element that is coupled to a turbine runner capable of rotating together with a pump impeller connected to an input member, and a lockup clutch capable of performing lockup in which the input member is engaged with the input element of the damper mechanism, and also capable of releasing the lockup.

### DESCRIPTION OF THE RELATED ART

Hydraulic transmission apparatuses that have been conventionally proposed as this type of hydraulic transmission apparatus include: a lockup clutch coupled to a front cover that is coupled to a crankshaft of an engine; a fluid coupling that is formed by a pump impeller integral with the front cover and a turbine; and a damper having an input-side member connected to both the lockup clutch and the turbine and an output-side member connected to an input shaft of a transmission (see, e.g., Japanese Patent Application Publication No. JP-A-2007-309334). In this hydraulic transmission apparatus, the turbine is coupled to the input-side member of the damper to form a so-called turbine damper. When a rotational force is applied from the lockup clutch, that is, when the lockup is being performed, the turbine that is heavy in weight is positioned on the upstream side in a power transmission path to shift a resonance point out of a normal region, thereby enhancing a damping effect.

### SUMMARY OF THE INVENTION

However, in the above conventional hydraulic transmission apparatus, torque from the fluid coupling (the turbine) is transmitted to the transmission side via a damper mechanism, even when the lockup is being released. Thus, the torque from the fluid coupling is damped by the damper mechanism, and required torque may not be able to be transmitted to the transmission side.

It is therefore a primary object of a hydraulic transmission apparatus of the present invention to improve torque transmission capability obtained when lockup is being released and damping capability obtained when the lockup is being performed, in a hydraulic transmission apparatus including a damper mechanism having an input element that is coupled to a turbine runner capable of rotating together with a pump impeller connected to an input member, and a lockup clutch capable of performing lockup in which the input member is engaged with the input element of the damper mechanism, and also capable of releasing the lockup.

The hydraulic transmission apparatus of the present invention uses the following means in order to achieve the above primary object.

A hydraulic transmission apparatus according to a first aspect of the present invention includes: a pump impeller connected to an input member that is coupled to a motor; a turbine runner capable of rotating together with the pump impeller; a damper mechanism having an input element that is coupled to the turbine runner, an elastic body that engages with the input element, and an output element that engages with the elastic body and that is coupled to an input shaft of a transmission device; a lockup clutch capable of performing lockup in which the input member is engaged with the input element of the damper mechanism, and capable of releasing the lockup; and an engagement mechanism that engages the turbine runner with the output element of the damper mechanism so that the turbine runner and the output element of the damper mechanism rotate integrally, when the lockup is being released by the lockup clutch, and that does not engage the turbine runner with the output element of the damper mechanism so that the turbine runner and the output element of the damper mechanism do not rotate integrally, when the lockup is being performed by the lockup clutch.

In the hydraulic transmission apparatus according to the first aspect, when the lockup is being released by the lockup clutch, the engagement mechanism engages the turbine runner with the output element of the damper mechanism, and the turbine runner and the output element of the damper mechanism rotate integrally. Thus, when the lockup is being released by the lockup clutch, the turbine runner is directly coupled to the output element of the damper mechanism. This can suppress damping of torque transmitted from the pump impeller to the turbine runner by the elastic body of the damper mechanism. When the lockup is being performed by the lockup clutch, the engagement mechanism does not engage the turbine runner with the output element of the damper mechanism, and the turbine runner and the output element of the damper mechanism do not rotate integrally. Thus, when the lockup is being performed by the lockup clutch, the turbine runner is capable of swinging with respect to the output element of the damper mechanism, and forms a so-called turbine damper. Accordingly, vibration can be satisfactorily damped by the turbine damper. Thus, the torque transmission capability obtained when the lockup is being released, and the damping capability obtained when the lockup is being performed can be improved in the hydraulic transmission apparatus.

According to a second aspect of the present invention, the turbine runner and the input element of the damper mechanism may be coupled together via a second elastic body that engages with both the turbine runner and the input element of the damper mechanism. Thus, when the lockup is being performed by the lockup clutch, the turbine runner is capable of swinging with respect to the output element of the damper mechanism, and forms together with the second elastic body a so-called dynamic damper. Accordingly, in the hydraulic transmission apparatus according to the second aspect, vibration is absorbed by the dynamic damper on a more upstream side in a power transmission path to the transmission device to which power from the input member is to be transmitted. Thus, vibration that is transmitted from the motor side to the hydraulic transmission apparatus, that is, the input member, is effectively absorbed (damped) by the dynamic damper before being damped by elements located on the downstream side of the input element of the damper mechanism, whereby transmission of the vibration to the downstream side of the input element can be satisfactorily suppressed. Note that in the case where the input element of the damper mechanism is formed by a plurality of members, the dynamic damper need only be configured to absorb vibration from any one of the plurality of members that form the input element.

Moreover, according to a third aspect of the present invention, the engagement mechanism may include a plurality of male-side engagement portions that are provided on one side of the turbine runner and the output element of the damper mechanism, and a plurality of female-side engagement portions that are provided on the other side of the turbine runner and the output element of the damper mechanism, and that are capable of engaging with the male-side engagement portions, respectively, and the male-side engagement portion and the female-side engagement portion may engage with each other with a clearance in a rotational direction, which is determined so that the male-side engagement portion contacts the female-side engagement portion in the rotational direction when the lockup is being released by the lockup clutch, and that the male-side engagement portion does not contact the female-side engagement portion in the rotational direction when the lockup is being performed by the lockup clutch. Thus, the turbine runner and the output element of the damper mechanism can be made to rotate integrally when the lockup is being released by the lockup clutch, and the turbine runner and the output element of the damper mechanism can be made not to rotate integrally when the lockup is being performed by the lockup clutch.

According to a fourth aspect of the present invention, the clearance may be determined so that the male-side engagement portion does not contact the female-side engagement portion in the rotational direction even if the second elastic body, which together with the turbine runner forms the dynamic damper, contracts when the lockup is being performed by the lockup clutch. Thus, vibration that is transmitted from the motor side to the input member by the dynamic damper formed by the turbine runner and the second elastic body can be more effectively damped when the lockup is being performed by the lockup clutch.

The hydraulic transmission apparatus according to a fifth aspect of the present invention may further include a frictional force generating mechanism placed between the input element of the damper mechanism and the turbine runner, and capable of applying to the input element a frictional force according to vibration that is transmitted from the input element to the turbine runner when the lockup is performed by the lockup clutch. That is, if vibration that is transmitted to the input member is damped by the dynamic damper when the lockup is performed by the lockup clutch and a rotational speed of the input member is included in a certain rotational speed range, resonance may occur in the input member and the input element of the damper mechanism when the rotational speed of the input member is included in another rotational speed range. Thus, the hydraulic transmission apparatus according to the fifth aspect includes the frictional force generating mechanism capable of applying to the input element the frictional force according to the vibration that is transmitted from the input element of the damper mechanism to the turbine runner when the lockup is performed by the lockup clutch. Accordingly, the rotational speed range of the input member in which the resonance occurs in association with the use of the dynamic damper is predetermined, and the frictional force according to the vibration that is transmitted from the input element of the damper mechanism to the turbine runner is applied from the frictional force generating mechanism to the input element when the rotational speed of the input member is included in this rotational speed range, whereby the resonance that occurs in association with the use of the dynamic damper can be satisfactorily damped, and transmission of the vibration to the downstream side of the input element can be satisfactorily suppressed.

According to a sixth aspect of the present invention, the frictional force generating mechanism may include a member that engages with one of the turbine runner and the input element of the damper mechanism with a clearance in the rotational direction, and may apply the frictional force to the input element when a twist angle of the dynamic damper that is formed by the turbine runner and the second elastic body becomes equal to or larger than the clearance. Thus, by determining the clearance according to the rotational speed range of the input member in which the resonance occurs in association with the use of the dynamic damper, the frictional force according to the vibration that is transmitted from the input element of the damper mechanism to the turbine runner can be more properly applied to the input element.

According to a seventh aspect of the present invention, the frictional force generating mechanism may be a multi-plate clutch mechanism that includes a first clutch plate that engages with one of the turbine runner and the input element of the damper mechanism with the clearance in the rotational direction, and a second clutch plate that engages with the other of the turbine runner and the input element of the damper mechanism. Thus, the frictional force according to the vibration that is transmitted from the input element of the damper mechanism to the turbine runner can be more properly applied to the input element when the rotational speed of the input member is included in the rotational speed range in which the resonance occurs in association with the use of the dynamic damper.

### BRIEF DESCRIPTION OF THE DRAWINGS

FIG. 1 is a partial cross-sectional view showing a hydraulic transmission apparatus 1 according to an embodiment of the present invention;

FIG. 2 is an enlarged view showing a main part of the hydraulic transmission apparatus 1;

FIG. 3 is an enlarged view showing a main part of the hydraulic transmission apparatus 1;

FIG. 4 is an illustration illustrating operation of the hydraulic transmission apparatus 1;

FIG. 5 is an illustration illustrating operation of the hydraulic transmission apparatus 1;

FIG. 6 is an illustration showing the relation between the rotational speed of an engine as a motor and the vibration level in the hydraulic transmission apparatus 1; and

FIG. 7 is a partial cross-sectional view showing a hydraulic transmission apparatus 1B according to a modification.

### DETAILED DESCRIPTION OF THE EMBODIMENT

An embodiment of the present invention will be described below.

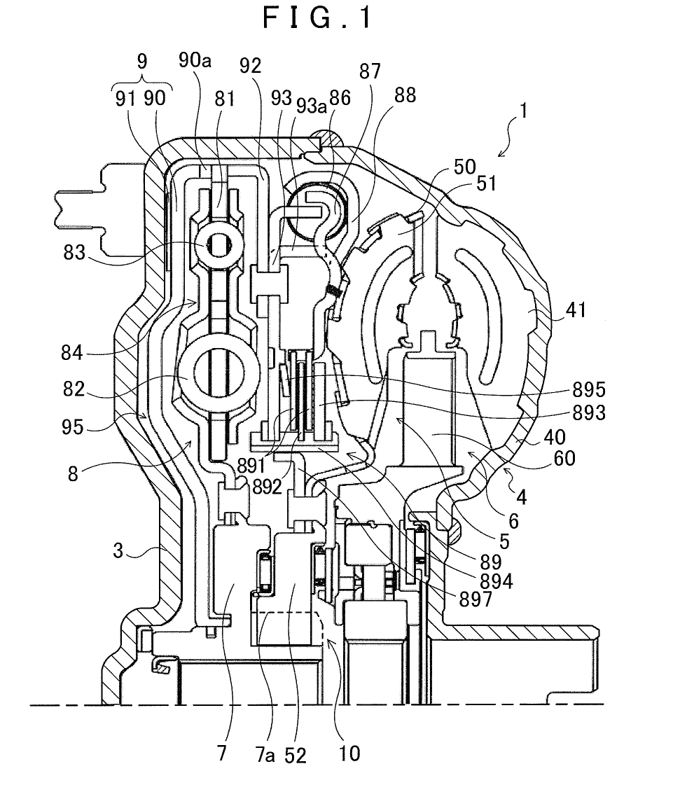

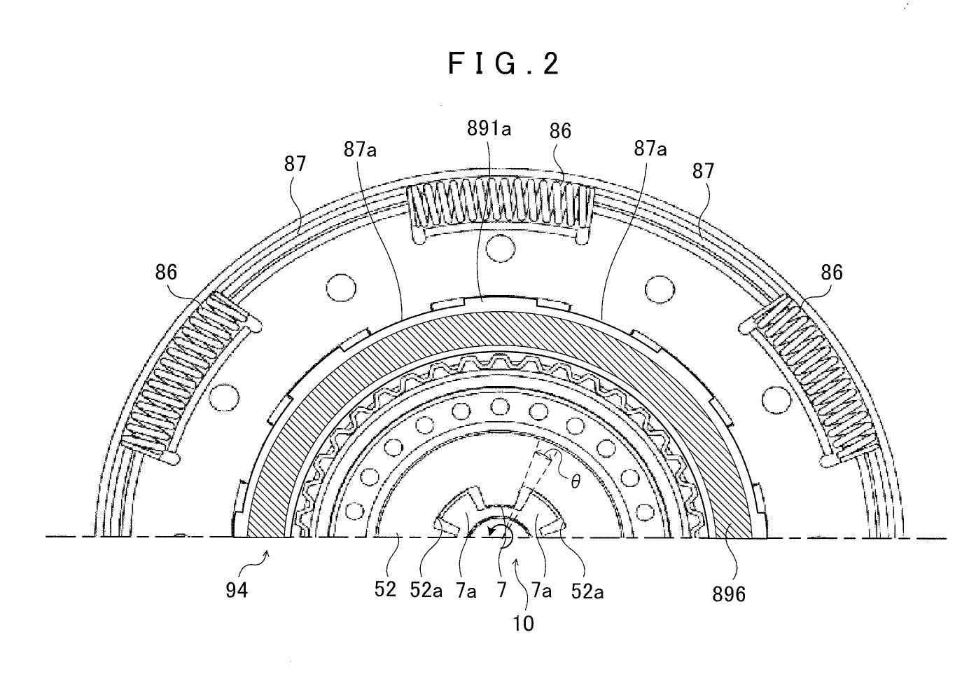

FIG. 1 is a partial cross-sectional view showing a hydraulic transmission apparatus 1 according to an embodiment of the present invention, and FIG. 2 is an enlarged view showing a main part of the hydraulic transmission apparatus 1. The hydraulic transmission apparatus 1 shown in these drawings is a torque converter that is mounted as a starting apparatus on a vehicle including an engine as a motor. The hydraulic transmission apparatus 1 includes: a front cover (an input member) 3 that is coupled to a crankshaft of the engine, not shown; a pump impeller (an input-side hydraulic transmission element) 4 fixed to the front cover 3; a turbine runner (an output-side hydraulic transmission element) 5 capable of rotating coaxially with the pump impeller 4; a stator 6 that straightens a flow of hydraulic oil (working fluid) from the turbine runner 5 to the pump impeller 4; a damper hub (an output member) 7 that is fixed to an input shaft of a transmission device as an automatic transmission (AT) or a continuously variable transmission (CVT), not shown; a damper mechanism 8 connected to the damper hub 7; and a single-plate friction type lockup clutch 9 capable of engaging (coupling) the front cover 3 with the damper mechanism 8 and of releasing the engagement (coupling) therebetween.

The pump impeller 4 has a pump shell 40 firmly fixed to the front cover 3, and a plurality of pump blades 41 arranged on the inner surface of the pump shell 40. The turbine runner 5 has a turbine shell 50, a plurality of turbine blades 51 arranged on the inner surface of the turbine shell 50, and a turbine hub 52 that is fixed to the turbine shell 50 via a rivet, that is connected to the turbine shell 50 via the rivet, and that engages coaxially with the damper hub 7 via an engagement mechanism 10. The pump impeller 4 and the turbine runner 5 face each other, and the stator 6 capable of rotating coaxially with the pump impeller 4 and the turbine runner 5 is placed between the pump impeller 4 and the turbine runner 5. The stator 6 has a plurality of stator blades 60, and the rotation direction of the stator 6 is set to only one direction by a one-way clutch 61. The pump impeller 4, the turbine runner 5, and the stator 6 form a torus (an annular flow path) that circulates the hydraulic oil.

As shown in FIG. 1, the lockup clutch 9 is placed near an inner wall surface on the engine side of the front cover 3 so as to be substantially parallel to the inner wall surface. The lockup clutch 9 includes an annular lockup piston 90 slidably supported in an axial direction by the dumper hub 7, and a friction member 91 bonded to a surface on the outer peripheral side of and on the front cover 3 side of the lockup piston 90. The lockup piston 90 is placed near a portion of the front cover 3 extending in a radial direction, and a lockup chamber 95, which is connected to a hydraulic control unit, not shown, via a hydraulic oil supply hole, not shown, and an oil passage formed in the input shaft, is defined between the back surface of the lockup piston 90 and the front cover 3.

The damper mechanism 8 includes: an annular drive member (an input element) 81 that is coupled to a cylindrical outer peripheral portion 90a of the lockup piston 90 extending in the axial direction of the hydraulic transmission apparatus 1, and that is placed substantially parallel to the lockup piston 90; a plurality of first coil springs (elastic bodies) 82 each having its one end fixed to the drive member 81; a plurality of second coil springs 83 each placed on the outer peripheral side of the hydraulic transmission apparatus 1, each having its one end fixed to the drive member 81 like the first coil springs 82, and each having higher rigidity than the first coil springs 82; and a driven member (an output element) 84 that is configured to be able to contact the respective other ends of the first coil springs 82 and the respective other ends of the second coil springs 83, and that is coupled (fixed) to the damper hub 7 via a plurality of rivets (see FIG. 1).

The driven member 84 is formed by two driven plates that face each other with the drive member 81 interposed therebetween, and that are coupled together via a plurality of rivets. The driven member 84 has a plurality of first spring accommodating portions each accommodating (supporting) the respective first coil spring 82 and each having a contact portion capable of contacting the other end (the end that is not fixed to the drive member 81) of the respective first coil spring 82, and a plurality of second spring accommodating portions each accommodating (supporting) the respective second coil spring 83 and each having a contact portion capable of contacting the other end (the end that is not fixed to the drive member 81) of the respective second coil spring 83. In the state where the damper mechanism 8 of the embodiment is attached, the contact portion of each first spring accommodating portion contacts the other end of the corresponding first coil spring 82, and a small gap is formed between the contact portion of each second spring accommodating portion and the other end of the corresponding second coil spring 83.

Thus, when the hydraulic oil in the lockup chamber 95 is discharged through the hydraulic oil supply hole, etc. by the hydraulic control unit, not shown, the lockup piston 90 moves toward the front cover 3, and the friction member 91 bonded to the lockup piston 90 contacts the front cover 3 and frictionally engages with the front cover 3, whereby the front cover 3 is engaged (coupled) with the damper hub 7 via the damper mechanism 8. Accordingly, power from the engine is transmitted to the input shaft of the transmission device via the front cover 3, the damper mechanism 8, and the damper hub 7. In this manner, in the case where torque that is transmitted from the lockup piston 90 to the drive member 81 of the damper mechanism 8 while the lockup is being performed is relatively small, and the amount of contraction of the first coil springs 82 is less than a predetermined amount, the second coil springs 83 do not contact the driven member 84, and the torque transmitted to the drive member 81 is output to the transmission device via the first coil springs 82, the driven member 84, and the damper hub 7. On the other hand, in the case where the torque that is transmitted from the lockup piston 90 to the drive member 81 of the damper mechanism 8 while the lockup is being performed is relatively large, and the amount of contraction of the first coil springs 82 is equal to or more than the predetermined amount, the gap between the second coil springs 83 and the driven member 84 is reduced, and the second coil springs 83 contact the driven member 84, whereby the torque transmitted to the drive member 81 is output to the transmission device via the first coil springs 82 and the second coil springs 83, the driven member 84, and the damper hub 7. As a result, if excessive torque is transmitted from the lockup piston 90 to the drive member 81 of the damper mechanism 8, the excessive torque is absorbed by the second coil springs 83. Note that in the lockup clutch 9 of the embodiment, the lockup is released when discharge of the hydraulic oil from the lockup chamber 95 is stopped.

As shown in FIG. 1, the hydraulic transmission apparatus 1 of the embodiment includes a turbine coupling member 87 fixed to the turbine shell 50 of the turbine runner 5, and a plurality of third coil springs 86 (second elastic bodies) arranged between the turbine coupling member 87 and the drive member 81 that forms the damper mechanism 8, so that the third coil springs 86 contact both the turbine coupling member 87 and the drive member 81. In the embodiment, one end of each third coil spring 86 contacts a contact portion formed in the turbine coupling member 87, and the other end of each third coil spring 86 contacts a contact portion formed in an annular contact member 93 that is coupled via a rivet to an annular coupling portion 92 extended radially inward from a free end of the cylindrical outer peripheral portion 90a of the lockup piston 90. Each third coil spring 86 is held by a plurality of spring support portions 88 each formed on the turbine coupling member 87 so as to extend in a circumferential direction, and a plurality of spring support portions 93a each formed on the contact member 93 so as to extend in the circumferential direction. Thus, since the turbine runner 5, i.e., the turbine coupling member 87 fixed to the turbine runner 5, engages with the drive member 81 of the damper mechanism 8 via the plurality of third coil springs 86, the plurality of third coil springs 86 that are the elastic bodies form a dynamic damper, together with the turbine runner 5 and the turbine coupling member 87. The turbine runner 5 and the turbine coupling member 87 serve as a mass that does not contribute to torque transmission between the front cover 3 (the input member) and the damper hub (the output member) 7 when the lockup is being performed in which the front cover 3 is engaged with the drive member 81 of the damper mechanism 8 by the lockup clutch 9.

The hydraulic transmission apparatus 1 of the embodiment further includes a frictional force generating mechanism 89 placed between the drive member 81 of the damper mechanism 8 and the turbine runner 5. The frictional force generating mechanism 89 is capable of applying to the drive member 81 a frictional force according to vibration that is transmitted from the drive member 81 to the turbine runner 5 when the front cover 3 is engaged with the drive member 81 of the damper mechanism 8 by the lockup clutch 9, and the rotational speed of the engine as the motor is included in a predetermined resonance rotational speed range.

As shown in FIG. 1, the frictional force generating mechanism 89 of the embodiment is formed as a so-called multi-plate clutch mechanism, and is placed between the drive member 81 and the turbine coupling member 87 fixed to the turbine runner 5. The frictional force generating mechanism 89 includes: a plurality of first clutch plates 891 that are formed in an annular shape, and that engage with the turbine coupling member 87 so as to be swingable about an axis of the hydraulic transmission apparatus 1; at least one second clutch plate 892 formed in an annular shape and placed between the first clutch plates 891; a base 894 that engages with the second clutch plate 892, and that, in the embodiment, holds both an inner peripheral portion of an engagement member 893 capable of frictionally engaging with the rightmost first clutch plate 891 in the drawing, and an inner peripheral portion of the contact member 93 described above; and a biasing member 895 such as a disc spring or a wave washer, that is placed between the contact member 93 and the leftmost first clutch plate 891 in the drawing, and that presses the first and second clutch plates 891, 892 toward the engagement member 893. A friction material 896 is bonded to substantially the entire front and rear surfaces of the first and clutch plates 891, 892. In the embodiment, the base 894 is rotatably supported about the axis of the hydraulic transmission apparatus 1 by a support member 897 that is fixed to the turbine shell 50 (the turbine hub 52) via a rivet. Moreover, as shown in the drawing, the contact member 93 and the engagement member 893 are rotatable integrally with the base 894, and movement of the contact member 93 and the engagement member 893 toward the damper mechanism 8 or toward the turbine runner 5 is restricted by snap rings fixed to the base 94.

The first clutch plate 891 has a plurality of radial protrusions 891a that are arranged at regular intervals in an inner peripheral portion of the first clutch plate 891, and that extend radially inward. The turbine coupling member 87 fixed to the turbine runner 5 has a plurality of (the same number as the radial protrusions 891a) axial protrusions 87a extending in the axial direction toward the front cover 3 (toward the engine) so as to be able to engage with the radial protrusions 891a of the first clutch plate 891. Each axial protrusion 87a of the turbine coupling member 87 has a shorter circumferential length than the interval between adjacent ones of the radial protrusions 891a of the first clutch plate 891, and as shown in FIG. 2, is located between adjacent ones of the radial protrusions 891a of the first clutch plate 891. Thus, the first clutch plate 891 engages with the turbine coupling member 87 (the turbine runner 5) with a clearance (a backlash) in a rotational direction.

The number of axial protrusions 87a and radial protrusions 891a, the interval between adjacent ones of the axial protrusions 87a, and the interval between adjacent ones of the radial protrusions 891a are determined so that each axial protrusion 87a of the turbine coupling member 87 does not contact any of the radial protrusions 891a located on both sides of the axial protrusion 87a, and the contact member 93, the engagement member 893, and the base 894 rotate integrally by the frictional force of the friction material 896, when the front cover 3 is not engaged with the drive member 81 of the damper mechanism 8 by the lockup clutch 9 during traveling of a vehicle, or when the rotational speed of the front cover 3 is not included in the above resonance rotational speed range even if the front cover 3 is engaged with the drive member 81 of the damper mechanism 8 by the lockup clutch 9 during traveling of the vehicle. In the embodiment, the number of axial protrusions 87a and radial protrusions 891a, the interval between adjacent ones of the axial protrusions 87a, and the interval between adjacent ones of the radial protrusions 891a are determined so that the clearance (the backlash) between the axial protrusion 87a of the turbine coupling member 87 and the radial protrusion 891a of the first clutch plate 891 is reduced (a twist angle of the dynamic damper becomes equal to or larger than the clearance) by vibration of the turbine runner 5, and the axial protrusion 87a contacts the radial protrusion 891a, even if the frequency of the vibration of the turbine runner 5 that engages with the drive member 81 via the plurality of third coil springs 86 is the smallest when the front cover 3 is engaged with the drive member 81 of the damper mechanism 8 by the lockup clutch 9 and the rotational speed of the engine as the motor, that is, the front cover 3, is included in the above resonance rotational speed range.

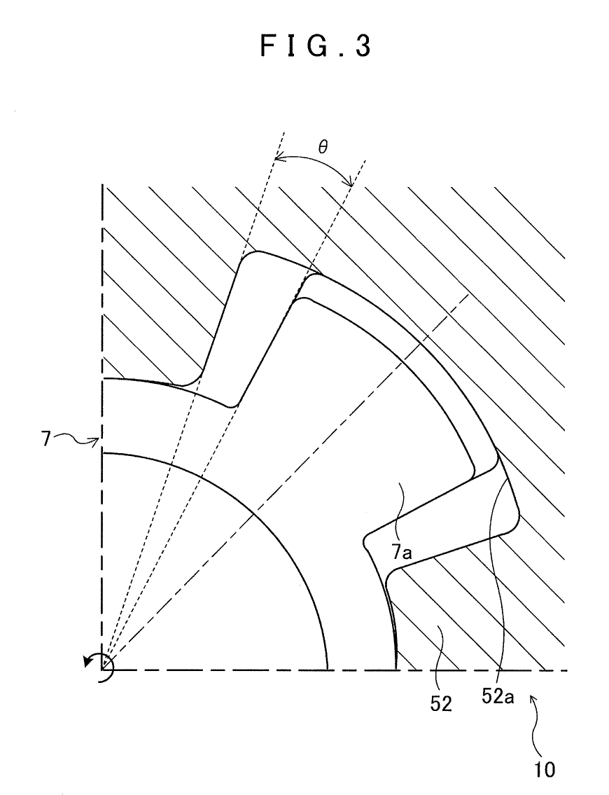

As shown in FIGS. 1 and 2, the engagement mechanism 10 engaging the damper hub 7, which is coupled to the driven member 84 as the output element of the above damper mechanism 8, with the turbine hub 52 is formed by a plurality of (four about the axis in the embodiment) protruding damper-side engagement portions (male-side engagement portions) 7a formed in the outer periphery on the right side in the drawing (on the side of the turbine runner 5) of the damper hub 7, and a plurality of recessed turbine-side engagement portions (female-side engagement portions) 52a formed in the inner periphery of the turbine hub 52 so as to engage with the damper-side engagement portions with a clearance (a backlash) in the rotational direction (the circumferential direction), respectively. As shown in FIGS. 2 and 3, a columnar surface formed between adjacent ones of the turbine-side engagement portions 52a is in slide contact with a columnar surface formed between adjacent ones of the damper-side engagement portions 7a, whereby the turbine runner 5 is swingably supported about the axis of the hydraulic transmission apparatus 1 with respect to the damper hub 7. In the embodiment, as shown in FIG. 3, an angle θ is determined so that the damper-side engagement portion 7a does not contact the turbine-side engagement portion 52a even if the third coil springs 86, which together with the turbine runner 5 and the turbine coupling member 87 forms the dynamic damper, contracts when the lockup is being performed by the lockup clutch 9, where “θ” represents an angle that defines the clearance in the rotational direction (the direction shown by an arrow in the drawing) between the damper-side engagement portion 7a and the turbine-side engagement portion 52a (between a side surface on the downstream side in the rotational direction of the damper-side engagement portion 7a and a side surface on the downstream side in the rotational direction of the turbine-side engagement portion 52a) when the centerline of the damper-side engagement portion 7a matches the centerline of the turbine-side engagement portion 52a corresponding to this damper-side engagement portion 7a.

That is, the angle θ is determined as a relative rotation angle between the damper hub 7 and the turbine runner 5 (the turbine hub 52), which allows the third coil springs 86 to contract sufficiently when the lockup is being performed.

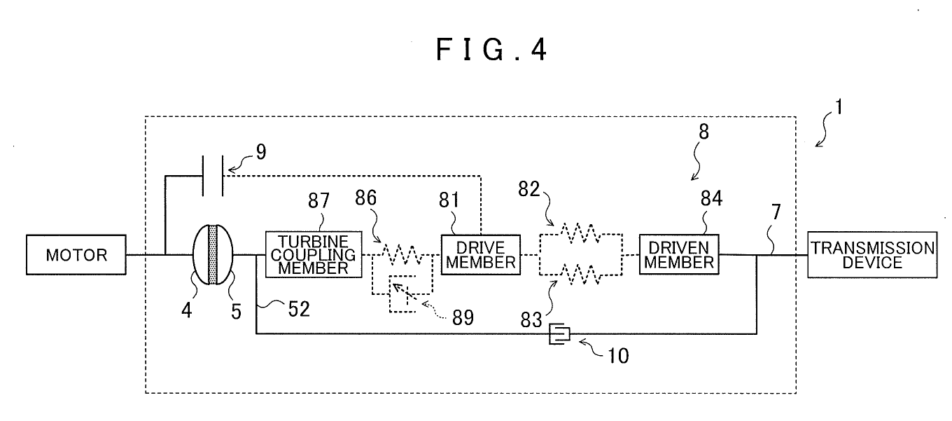

Operation of the above hydraulic transmission apparatus 1 will be described below with reference to FIGS. 4 to 6, etc. In the hydraulic transmission apparatus 1, when the lockup is released in which the front cover 3 is not engaged with the drive member 81 by the lockup clutch 9, the power from the engine as the motor is transmitted via a path formed by the front cover 3, the pump impeller 4, and the turbine runner 5. Thus, the turbine runner 5 (the turbine hub 52) rotates relative to the damper hub 7, and the clearance in the rotational direction between the damper-side engagement portion 7a and the turbine-side engagement portion 52a that form the engagement mechanism 10 is reduced, whereby the turbine runner 5 (the turbine hub 52) is engaged with the turbine hub 7. As a result, the turbine hub 52 is engaged by the engagement mechanism 10 with the damper hub 7 coupled to the driven member (the output element) 84 of the damper mechanism 8, and the turbine runner 5 and the damper hub 7 rotate integrally. Thus, when the lockup is released, as shown by solid lines in FIG. 4, the power from the engine as the motor is transmitted to the input shaft of the transmission device via a path formed by the front cover 3, the pump impeller 4, the turbine runner 5, the turbine hub 52, the engagement mechanism 10, and the damper hub 7. In this manner, when the lockup is released, the turbine runner 5 is directly coupled to the damper hub 7, that is, the driven member 84 as the output element of the damper mechanism 8. This can suppress damping of the torque transmitted from the pump impeller 4 to the turbine runner 5 by the first coil springs 82 and the second coil springs 83 of the damper mechanism 8.

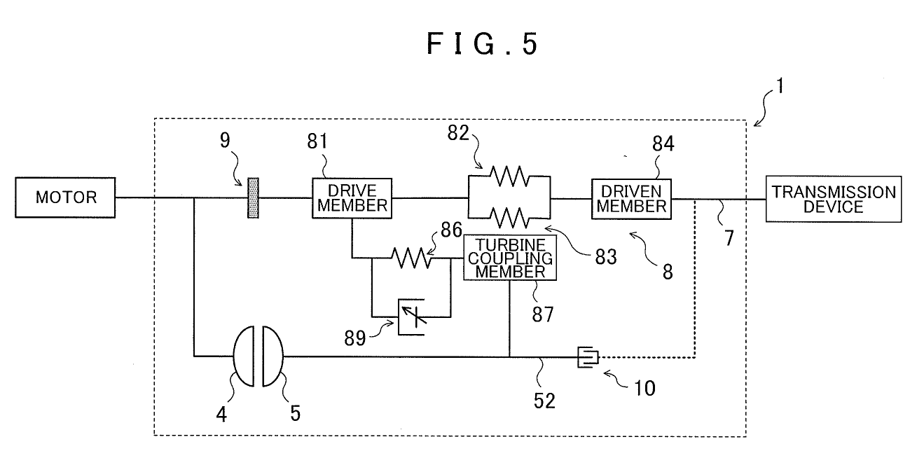

On the other hand, when the lockup is performed in which the front cover 3 is engaged with the drive member 81 of the damper mechanism 8 by the lockup clutch 9, as shown by solid lines in FIG. 5, the power from the engine as the motor is transmitted to the input shaft of the transmission device via a path formed by the front cover 3, the lockup clutch 9, the drive member 81, the plurality of first and second coil springs 82, 83, the driven member 84, and the damper hub 7. At this time, variation in torque that is input to the front cover 3 is absorbed mainly by the first and second coil springs 82, 83 of the damper mechanism 8.

The clearance (the angle θ) in the rotational direction between the damper-side engagement portion 7a and the turbine-side engagement portion 52a that form the engagement mechanism 10 is determined so that the damper-side engagement portion 7a does not contact the turbine-side engagement portion 52a even if the third coil springs 86 contract when the lockup is being performed. That is, when the lockup is being performed, the turbine runner 5 (the turbine hub 52) and the damper hub 7 rotate relative to each other rather than rotate integrally, and the third coil springs 86 are allowed to contract sufficiently. In the hydraulic transmission apparatus 1 of the embodiment, the turbine runner 5, that is, the turbine coupling member 87 fixed to the turbine runner 5, is engaged with the drive member 81 of the damper mechanism 8 via the plurality of third coil springs 86. Thus, when the lockup is being performed by the lockup clutch 9, the plurality of third coil springs 86 that are the elastic bodies form the dynamic damper, together with the turbine runner 5 and the turbine coupling member 87. The turbine runner 5 and the turbine coupling member 87 serve as the mass that does not contribute to torque transmission between the front cover 3 (the input member) and the damper hub (the output member) 7 when the lockup is being performed. Vibration that is transmitted from the motor side to the front cover 3 can be more effectively damped by such a dynamic damper.

That is, in the hydraulic transmission apparatus 1 of the embodiment, the turbine coupling member 87 fixed to the turbine runner 5 engages via the plurality of third coil springs 86 (the elastic bodies) with the drive member 81. Among the plurality of elements that form the damper mechanism 8, the drive member 81 has higher vibrational energy than the driven member 84 especially when the lockup is performed and the rotational speed of the front cover 3 (the engine speed) is relatively low. Vibration is absorbed by the dynamic damper, which is formed by the plurality of third coil springs 86, and the turbine runner 5 and the turbine coupling member 87 serving as the mass, on a more upstream side in a power transmission path to the transmission device to which the power from the front cover 3 is to be transmitted. Thus, when the lockup is performed, vibration that is transmitted from the engine side to the hydraulic transmission apparatus 1, that is, the front cover 3, is effectively absorbed (damped) by the dynamic damper before being damped by the elements located on the downstream side of the drive member 81 of the damper mechanism 8, whereby transmission of the vibration to the downstream side of the drive member 81 can be satisfactorily suppressed.

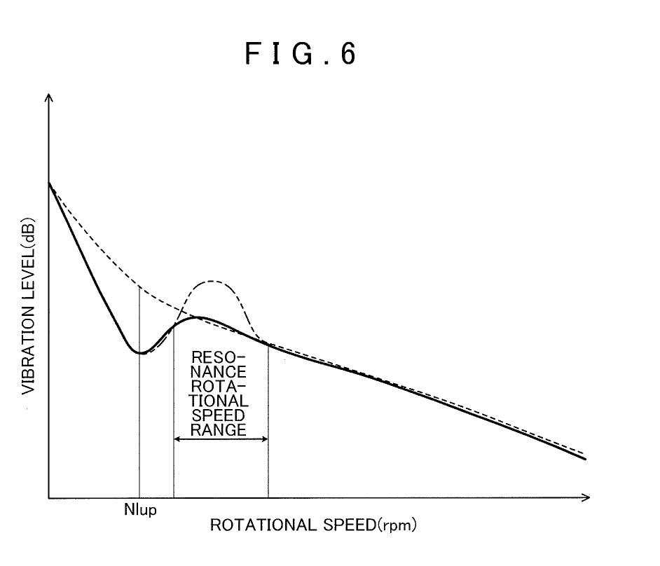

Thus, in the hydraulic transmission apparatus 1 of the embodiment, the resonance frequency of the dynamic damper that is formed by the plurality of third coil springs 86 and the turbine runner 5 and the turbine coupling member 87 serving as the mass, that is, the rigidity (the spring constant) of the third coil springs 86 and the weight (inertia) of the turbine runner 5, the turbine coupling member 87, and the like are adjusted based on the number of cylinders of the engine as the motor, and the engine speed when the lockup is performed. Accordingly, as shown by a solid line in FIG. 6, vibration that is transmitted from the engine as the motor to the hydraulic transmission apparatus 1, that is, the front cover 3, when the engine speed is relatively low can be effectively absorbed (damped) by the dynamic damper, and transmission of the vibration to the downstream side of the drive member 81 can be satisfactorily suppressed, as compared to, for example, the case where the dynamic damper is coupled to the driven member 84 of the damper mechanism 8 (see a dashed line in FIG. 6). As a result, in the hydraulic transmission apparatus 1 of the embodiment, power transmission efficiency can be improved by performing the lockup when the engine speed reaches a relatively low lockup rotational speed Nlup of about 1,000 rpm, for example, and vibration that tends to be produced between the front cover 3 and the drive member 81 when the rotational speed of the front cover 3 (the engine speed) is relatively low at the time of and after engagement of the lockup clutch 9, can be satisfactorily damped.

If the vibration that is transmitted to the front cover 3 is damped by the dynamic damper and the vibration level is reduced when the front cover 34 is engaged with the drive member 81 of the damper mechanism 8 by the lockup clutch 9 and the rotational speed of the front cover 3 (the engine speed) is included in a low rotational speed range including the lockup rotational speed Nlup, resonance may occur in the front cover 3 and the drive member 81 when the rotational speed of the front cover 3 (the engine speed) increases thereafter, as shown by two-dot chain line in FIG. 6. Thus, in the embodiment, the rotational speed range of the front cover 3 (the engine) in which the resonance occurs in association with the use of the dynamic damper is predetermined as the resonance rotational speed range described above, and the frictional force according to the vibration that is transmitted from the drive member 81 to the turbine runner 5 via the third coil springs 86 and the turbine coupling member 87 is applied from the frictional force generating mechanism 89 to the drive member 81 when the rotational speed of the front cover 3 (the engine) is included in the resonance rotational speed range.

That is, when the clearance (the backlash) between the axial protrusion 87a of the turbine coupling member 87 and the radial protrusion 891a of the first clutch plate 891 that forms the frictional force generating mechanism 89 is reduced and the axial protrusion 87a contacts the radial protrusion 891a due to the vibration of the turbine runner 5 that engages with the drive member 81 (the contact member 93) of the damper mechanism 8 via the third coil springs 86, the turbine coupling member 87, the contact member 93, and the coupling portion 92 of the lockup piston 90, the first clutch plate 891 is moved (rotated) with respect to the drive member 81 by the turbine runner 5. Thus, the frictional force according to the vibration of the turbine runner 5 can be applied to the drive member 81 via the first and second clutch plates 891, 892, the friction material 896, the engagement member 893, the base 894, the contact portion 93, and the coupling portion 92 of the lockup piston 90. In this manner, as shown in FIG. 6, the resonance that occurs in association with the use of the dynamic damper can be satisfactorily damped, and transmission of the vibration to the downstream side of the drive member 81 can be satisfactorily suppressed.

As described above, when the lockup is being released by the lockup clutch 9 in the hydraulic transmission apparatus 1 of the embodiment, the turbine runner 5 is engaged with the damper hub 7 coupled to the driven member 84 as the output element of the damper mechanism 8 by the engagement mechanism 10, and the turbine runner 5 and the damper hub 7 rotate integrally. Thus, when the lockup is being released by the lockup clutch 9, the turbine runner 5 is directly coupled to the damper hub 7 (the driven member 84 of the damper mechanism 8). This can suppress damping of the torque transmitted from the pump impeller 4 to the turbine runner 5 by the first coil springs 82 and the second coil springs 83 of the damper mechanism 8. When the lockup is being performed by the lockup clutch 9, the turbine runner 5 is not engaged with the damper hub 7 (the driven member 84 of the damper mechanism 8) by the engagement mechanism 10, and the turbine runner 5 and the damper hub 7 do not rotate integrally. Thus, when the lockup is being performed by the lockup clutch 9, the turbine runner 5 is capable of swinging with respect to the damper hub 7 (the output element) of the damper mechanism 8, and forms the dynamic damper together with the third coil springs 86, whereby vibration can be satisfactorily damped by the dynamic damper. Accordingly, the torque transmission capability obtained when the lockup is being released and the damping capability obtained when the lockup is being performed can be improved in the hydraulic transmission apparatus 1 of the embodiment.

In the embodiment, the turbine runner 5 is coupled to the drive member 81 as the input element of the damper mechanism 8 via the third coil springs 86 that engage with both the turbine runner 5 and the drive member 81. Thus, vibration is absorbed by the dynamic damper, which is formed by the turbine runner 5, the turbine coupling member 87, and the third coil springs 86, on the more upstream side in the power transmission path to the transmission device to which the power from the front cover 3 is to be transmitted. Accordingly, vibration that is transmitted from the motor side to the hydraulic transmission apparatus, that is, the front cover 3, can be effectively absorbed (damped) by the dynamic damper before being damped by the elements located on the downstream side of the drive member 81 (the input element) of the damper mechanism 8, whereby transmission of the vibration to the downstream side of the drive member 81 (the input element) can be satisfactorily suppressed. Note that in the case where the drive member 81 (the input element) of the damper mechanism 8 is formed by a plurality of members, the dynamic damper need only be configured so as to absorb vibration from any one of the plurality of members that form the drive member 81 (the input element). It should be noted that the third coil springs 86 and the frictional force generating mechanism 89 may be omitted from the above hydraulic transmission apparatus 1. In this case, when the lockup is being performed by the lockup clutch 9, the turbine runner 5 is capable of swinging with respect to the damper hub 7 (the driven member 84 of the damper mechanism 8), and forms a so-called turbine damper. Thus, vibration can also be satisfactorily damped by such a turbine damper.

Moreover, the engagement mechanism 10 of the embodiment includes the plurality of damper-side engagement portions 7a (the male-side engagement portions) provided on the driven member 84 side of the damper mechanism 8, that is, provided in the damper hub 7, and the plurality of turbine-side engagement portions 52a (the female-side engagement portions) provided in the turbine runner 5 and capable of engaging with the damper-side engagement portions 7a (the male-side engagement portions), respectively. The damper-side engagement portion 7a engages with the turbine-side engagement portion 52a with the clearance θ in the rotational direction based on the angle θ determined so that the damper-side engagement portion 7a contacts the turbine-side engagement portion 52a in the rotational direction when the lockup is being released by the lockup clutch 9, and that the damper-side engagement portion 7a does not contact the turbine-side engagement portion 52a in the rotational direction when the lockup is being performed by the lockup clutch 9. The angle θ that defines the clearance is determined so that the damper-side engagement portion 7a does not contact the turbine-side engagement portion 52a in the rotational direction even if the third coil springs 86, which form the dynamic damper together with the turbine runner 5, contract when the lockup is being performed by the lockup clutch 9. Thus, the turbine runner 5 and the damper hub 7 (the driven member 84) of the damper mechanism 8 are made to rotate integrally when the lockup is being released by the lockup clutch 9, and the turbine runner 5 and the damper hub 7 (the driven member 84) of the damper mechanism 8 are made not to rotate integrally when the lockup is being performed by the lockup clutch 9, whereby the vibration that is transmitted from the engine to the front cover 3 can be more efficiently damped by the dynamic damper. Note that although the damper-side engagement portions 7a are protruding (male) engagement portions, and the turbine-side engagement portions 52a are recessed (female) engagement portions in the above embodiment, the damper-side engagement portions 7a may be recessed (female) engagement portions, and the turbine-side engagement portions 52a may be protruding (male) engagement portions.

The hydraulic transmission apparatus 1 is placed between the drive member 81 of the damper mechanism 8 and the turbine runner 5, and includes the frictional force generating mechanism 89 capable of applying to the drive member 81 the frictional force according to the vibration that is transmitted from the drive member 81 to the turbine runner 5 when the lockup is performed by the lockup clutch 9 and the rotational speed of the front cover 3 is included in the predetermined rotational speed range. That is, if the vibration that is transmitted to the front cover 3 is damped by the dynamic damper when the lockup is performed by the lockup clutch 9 and the rotational speed of the front cover 3 is included in a certain rotational speed range, resonance may occur in the front cover 3 and the drive member 81 of the damper mechanism 8 when the rotational speed of the front cover 3 is included in another rotational speed range. Thus, in the hydraulic transmission apparatus 1 of the embodiment, the rotational speed range of the front cover 3 in which the resonance occurs in association with the use of the dynamic damper is predetermined, and the frictional force according to the vibration that is transmitted from the drive member 81 of the damper mechanism 8 to the turbine runner 5 is applied from the frictional force generating mechanism 89 to the drive member 81 when the rotational speed of the front cover 3 is included in this rotational speed range.

In this manner, the resonance that occurs in association with the use of the dynamic damper can be satisfactorily damped, and transmission of the vibration to the downstream side of the drive member 81 can be satisfactorily suppressed.

Moreover, the frictional force generating mechanism 89 of the embodiment is formed as the multi-plate clutch mechanism including the first clutch plates 891 that engage with the turbine coupling member 87 (the turbine runner 5) with the clearance in the rotational direction, and the second clutch plate 892 that engages with the base 894 coupled to the drive member 81 of the damper mechanism 8 via the contact member 93, etc. Thus, the frictional force according to the vibration that is transmitted from the drive member 81 of the damper mechanism 8 to the turbine runner 5 can be more properly applied to the drive member 81 when the rotational speed of the front cover 3 is included in the rotational speed range in which the resonance occurs in association with the use of the dynamic damper. Note that in the frictional force generating mechanism 89, the first clutch plates 891 may be engaged with the turbine coupling member 87, and the second clutch plate 892 may be engaged with the base 894 with a clearance (a backlash) in the rotational direction.

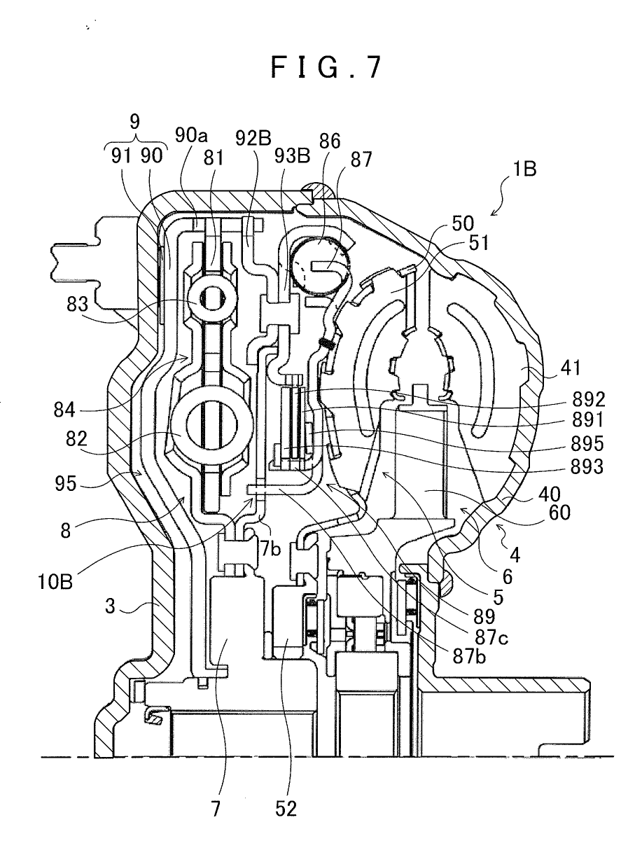

FIG. 7 is a partial cross-sectional view showing a hydraulic transmission apparatus 1B according to a modification. An engagement mechanism 10B of the hydraulic transmission apparatus 1B shown in the drawing is formed by an annular member 7b that is fixed (coupled) to the damper hub 7 via a rivet and that has a plurality of holes (female-side engagement portions) as the damper-side engagement portions, and a turbine-side engagement portion 87b that is extended from the turbine coupling member 87 and that engages with the holes of the annular member 7b with a clearance in the rotational direction. Such an engagement mechanism 10B can also engage the turbine runner 5 with the damper hub 7 (the driven member 84 of the damper mechanism 8) so that the turbine runner 5 and the damper hub 7 rotate integrally, when the lockup is being released by the lockup clutch 9, and can cause the turbine runner 5 and the damper hub 7 not to rotate integrally when the lockup is being performed by the lockup clutch 9. Note that as shown in the drawing, the frictional force generating mechanism 89 of the hydraulic transmission apparatus 1B of FIG. 7 includes the first clutch plate 891 that engages with a support portion 87c extended from the turbine coupling member 87, with a clearance (a backlash) in the rotational direction, the second clutch plate 892 that engages with a contact member 93B that contacts the third coil springs 86, and the engagement member 893 that is held by the support portion 87c of the turbine coupling member 87. The contact member 93B is fixed via a rivet to a coupling member 92B that engages with the cylindrical outer peripheral portion 90a of the lockup piston 90, and that is supported in the radial direction by the annular member 7b. Thus, the base 894 of the hydraulic transmission apparatus 1 can be omitted in the hydraulic transmission apparatus 1B.

The correspondence between main elements of the embodiment and main elements of the invention described in the section “SUMMARY OF THE INVENTION” will be described below. In the above embodiment, the hydraulic transmission apparatus 1, which includes: the pump impeller 4 connected to the front cover 3 as the input member coupled to the engine as the motor; the turbine runner 5 capable of rotating together with the pump impeller 4; the damper mechanism 8 having the drive member (the input element) 81 that is coupled to the turbine runner 5, the first and second coil springs 82, 83 that are the elastic bodies and engage with the drive member 81, and the driven member (the output element) 84 that is coupled via the damper hub 7 to the component to which the power from the engine is to be transmitted; and the lockup clutch 9 capable of performing the lockup in which the front cover 3 is engaged with the drive member 81 of the damper mechanism 8, and capable of releasing the lockup, corresponds to the “hydraulic transmission apparatus.” The engagement mechanism 10 that engages the turbine runner 5 with the damper hub 7 (the driven member 84) so that the turbine runner 5 and the damper hub 7 (the driven member 84) rotate integrally when the lockup is being released by the lockup clutch 9 and that does not engage the turbine runner 5 with the damper hub 7 (the driven member 84) so that the turbine runner 5 and the damper hub 7 (the driven member 84) do not rotate integrally when the lockup is being performed by the lockup clutch 9 corresponds to the “engagement mechanism.” The third coil springs 86 that engage with both the turbine runner 5 and the drive member 81 of the damper mechanism 8 correspond to the “second elastic body.”

It should be noted that the correspondence between the main elements of the embodiment and the main elements of the invention described in the section “SUMMARY OF THE INVENTION” is shown by way of example only in order to specifically describe the invention described in the section “SUMMARY OF THE INVENTION,” and thus does not limit the elements of the invention described in the section “SUMMARY OF THE INVENTION.” That is, the embodiment is merely a specific example of the invention described in the section “SUMMARY OF THE INVENTION,” and the invention described in the section “SUMMARY OF THE INVENTION” should be construed based on the description in that section.

It should be noted that although the embodiment of the invention is described above, the present invention is not limited to the above embodiment, and various modifications can be made without departing from the subject of the present invention.

The present invention can be used in the field of manufacturing hydraulic transmission apparatuses, etc.

What is claimed is:

1. A hydraulic transmission apparatus comprising:
a pump impeller connected to an input member that is coupled to a motor;
a turbine runner capable of rotating together with the pump impeller;
a damper mechanism having an input element that is coupled to the turbine runner, an elastic body that engages with the input element, and an output element that engages with the elastic body and that is coupled to an input shaft of a transmission device;
a lockup clutch capable of performing lockup in which the input member is engaged with the input element of the damper mechanism, and capable of releasing the lockup; and
an engagement mechanism that engages the turbine runner with the output element of the damper mechanism so that the turbine runner and the output element of the damper mechanism rotate integrally, when the lockup is being released by the lockup clutch, and that does not engage the turbine runner with the output element of the damper mechanism so that the turbine runner and the output element of the damper mechanism do not rotate integrally, when the lockup is being performed by the lockup clutch.

2. The hydraulic transmission apparatus according to claim 1, wherein
the turbine runner and the input element of the damper mechanism are coupled together via a second elastic body that engages with both the turbine runner and the input element of the damper mechanism.

3. The hydraulic transmission apparatus according to claim 2, wherein
the engagement mechanism includes a plurality of male-side engagement portions that are provided on one side of the turbine runner and the output element of the damper mechanism, and a plurality of female-side engagement portions that are provided on the other side of the turbine runner and the output element of the damper mechanism, and that are capable of engaging with the male-side engagement portions, respectively, and
the male-side engagement portion and the female-side engagement portion engage with each other with a clearance in a rotational direction, which is determined so that the male-side engagement portion contacts the female-side engagement portion in the rotational direction when the lockup is being released by the lockup clutch, and that the male-side engagement portion does not contact the female-side engagement portion in the rotational direction when the lockup is being performed by the lockup clutch.

4. The hydraulic transmission apparatus according to claim 3, wherein
the clearance is determined so that the male-side engagement portion does not contact the female-side engagement portion in the rotational direction even if the second elastic body, which together with the turbine runner forms a dynamic damper, contracts when the lockup is being performed by the lockup clutch.

5. The hydraulic transmission apparatus according to claim 2, further comprising:
a frictional force generating mechanism placed between the input element of the damper mechanism and the turbine runner, and capable of applying to the input element a frictional force according to vibration that is transmitted from the input element to the turbine runner when the lockup is performed by the lockup clutch.

6. The hydraulic transmission apparatus according to claim 5, wherein
the frictional force generating mechanism includes a member that engages with one of the turbine runner and the input element of the damper mechanism with a clearance in the rotational direction, and applies the frictional force to the input element when a twist angle of the dynamic damper that is formed by the turbine runner and the second elastic body becomes equal to or larger than the clearance.

7. The hydraulic transmission apparatus according to claim 5, wherein
the frictional force generating mechanism is a multi-plate clutch mechanism that includes a first clutch plate that engages with one of the turbine runner and the input element of the damper mechanism with a clearance in the rotational direction, and a second clutch plate that engages with the other of the turbine runner and the input element of the damper mechanism.

8. The hydraulic transmission apparatus according to claim 4, further comprising:
a frictional force generating mechanism placed between the input element of the damper mechanism and the turbine runner, and capable of applying to the input element a frictional force according to vibration that is transmitted from the input element to the turbine runner when the lockup is performed by the lockup clutch.

9. The hydraulic transmission apparatus according to claim 8, wherein
the frictional force generating mechanism includes a member that engages with one of the turbine runner and the input element of the damper mechanism with a clearance in the rotational direction, and applies the frictional force to the input element when a twist angle of the dynamic damper that is formed by the turbine runner and the second elastic body becomes equal to or larger than the clearance.

10. The hydraulic transmission apparatus according to claim 9, wherein
the frictional force generating mechanism is a multi-plate clutch mechanism that includes a first clutch plate that engages with one of the turbine runner and the input element of the damper mechanism with a clearance in the rotational direction, and a second clutch plate that engages with the other of the turbine runner and the input element of the damper mechanism.

11. A hydraulic transmission apparatus comprising:
a pump impeller connected to an input member that is coupled to a motor;
a turbine runner capable of rotating together with the pump impeller;
a damper mechanism having an input element that is coupled to the turbine runner, an elastic body that engages with the input element, and an output element that engages with the elastic body and that is coupled to an input shaft of a transmission device;
a lockup clutch capable of performing lockup in which the input member is engaged with the input element of the damper mechanism, and capable of releasing the lockup; and
an engagement mechanism that engages the turbine runner with the output element of the damper mechanism so that the turbine runner and the output element of the damper mechanism rotate integrally, when the lockup is being released by the lockup clutch, and that does not engage the turbine runner with the output element of the damper mechanism so that the turbine runner and the output element of the damper mechanism do not rotate integrally, when the lockup is being performed by the lockup clutch.
